(19) United States
(12) Patent Application Publication
(10) Pub. No.: US 2023/0332514 A1
(43) Pub. Date: Oct. 19, 2023

(54) NOZZLE SEGMENT, STEAM TURBINE WITH DIAPHRAGM OF MULTIPLE NOZZLE SEGMENTS AND METHOD FOR ASSEMBLY THEREOF

(71) Applicant: General Electric Company, Schenectady, NY (US)

(72) Inventors: Chris BULLOUGH, Warwickshire (GB); Rolf DOEBLER, Mannheim, Baden-Wurttemberg (DE); Huascar LORINI, Mannheim, Baden-Wurttemberg (DE); Steve OSGERBY, Warwickshire (GB); Simon SEGAT, Baden, Aargau (CH)

(21) Appl. No.: 18/044,031

(22) PCT Filed: Sep. 7, 2021
(86) PCT No.: PCT/US2021/049259

§ 371 Date: Mar. 3, 2023

(30) Foreign Application Priority Data
Sep. 10, 2020 (EP) 20195499.7

(51) Int. Cl. F01D 9/04; F01D 5/28; F01D 25/24

(52) U.S. Cl. CPC F01D 25/246; F01D 5/288; F01D 9/042; F05D 2220/31; F05D 2260/37; F05D 2300/171; F05D 2300/50212; F05D 2300/611

(57) ABSTRACT

A integral or monolithic nozzle segment having airfoils According to an aspect of the invention a steam turbine has a casing supporting multiple nozzle segments forming a diaphragm with the airfoils located in a channel through which working fluid flows. The diaphragm surrounds a rotary axis of a steam turbine coaxially and consists of a plurality of individual nozzle segments. The nozzle segments and the casing of the steam turbine have substantially equal thermal expansion coefficients. The casing and the nozzle segments are made of different materials and particularly different martensitic steel types. Each nozzle segment may have a core comprising martensitic steel having a minimum creep strength that fulfills the following conditions at a temperature of 580° C.: at least 105 hours under a tensile stress of at least 100 MPa or at least 125 MPa or at least 150 MPa.

The invention refers to a nozzle segment of a diaphragm, a steam turbine having a casing and a diaphragm attached thereto and a method for assembling the diaphragm.

US 2006/0245923 A1 discloses an arrangement of turbine nozzle segments comprising a first ring segment, a second ring segment and multiple airfoils extending there between. The nozzle segments are manufactured from a solid ring.

A nozzle box made of individual nozzle segments, each comprising multiple airfoils is known from US 7,207,773 B2. The working fluid flows through the nozzle box in an axial direction parallel to a rotary axis of the turbine.

US 4,776,765 A refers to a technique to reduce solid particle erosion by providing a protection device over at least a portion of the suction side of a nozzle partition. The nozzles can be made of martensitic chromium stainless steel and provided with a surface coating as protection means.

Further embodiments of generally known nozzle arrangements are described in US 4,025,229 A, US 5,807,074 A, US 6,631,858 B1, US 6,754,956 B1 and US 2003/0103845 A1.

US 4,948,333 A discloses a diaphragm supported by a casing of a turbine for redirecting a radial working flu-id flow. The diaphragm comprises two rings extending coaxially to the rotary axis of the turbine and supporting airfoils therebetween. The airfoils deflect a working fluid flow that is orientated substantially in radial direction upstream of the diaphragm into a direction that comprises a component of the working fluid flow in circumferential direction around the rotary axis. A similar diaphragm is also disclosed in EP 3 412 872 B1.

Another device for deflecting a working fluid flow from a radial direction into an axial direction is known from US 7,670,109 B2.

Some types of steam turbines include diaphragms in order to direct the flow of a working fluid into a first stage of turbine rotor blades connected to a rotatable rotor. The rotor includes a shaft extending in axial direction and defining the rotary axis. The diaphragm may also be referred to as “nozzle assembly”. The diaphragm comprises a plurality of airfoils that can be referred to as “nozzles”.

At least some steam turbines suffered in the past from damages of diaphragms, e.g. partially cracked or bent or even ruptured airfoils. In order to mitigate these failures and to increase the reliability and lifetime of the components, measures have been taken to reduce thermal stress on the components, e.g. by increasing radial and axial clearances in the connection between the diaphragm and the casing of the steam turbine. However, depending on the operating condition, increased clearances could lead to a loss in efficiency due to leakage of the working fluid.

Accordingly, a desire exists to provide a steam turbine with diaphragm providing high reliability and lifetime and allowing a simplified assembly. Particularly the steam turbine shall be configured for an operating temperature range of the working fluid above 570° C. (Ultra Super Critical temperature range of the working fluid).

This object is solved with a nozzle segment according to claim 1, a steam turbine according to claim 11 and a method of assembling a diaphragm to a casing according to claim 16.

The steam turbine comprises a casing surrounding at least one turbine pressure section having multiple rows of stationary vanes coupled to the casing and rotatable rotor blades coupled to a rotor of the steam turbine.

For guiding working fluid in the at least one turbine pressure section a diaphragm is attached to the casing, particularly downstream an inlet channel and upstream a first turbine pressure section. The diaphragm is particularly configured to direct the flow of the working fluid toward the rotor blades. In an embodiment the diaphragm is ring-shaped and surrounds the rotary axis of the rotor of the steam turbine coaxially.

The diaphragm of the steam turbine can include separated diaphragm sections each of which may extend substantially in a semicircular manner around the rotary axis of the steam turbine. Each diaphragm section is attached to a part of the casing (e.g. an assigned casing half) of the steam turbine.

In one aspect of the present invention a nozzle segment is provided for the diaphragm of the steam turbine. Each nozzle segment comprises a first ring segment and a second ring segment that extend parallel to each other and that are arranged with distance to each other in an axial direction. The first and the second ring segments support multiple airfoils that extend from the first ring segment to the second ring segment and define nozzle openings between two directly adjacent airfoils. The first ring segment can be referred to as root and the second ring segment can be referred to as shroud. Preferably the shroud is less thick than the root viewed or measured in axial direction. For example, each nozzle segment may comprise 8-12 airfoils. The diaphragm may comprise 8 or more nozzle segments. However the number of nozzle segments can vary in different embodiments.

The first and second ring segment of each nozzle segment extends along a circular arc around the rotary axis of the steam turbine. All of the nozzle segments together form a circular ring-shaped diaphragm.

According to an aspect of the invention the thermal expansion coefficient of each nozzle segment is substantially equal to the thermal expansion coefficient of the casing of the steam turbine that supports the nozzle segments. Preferably the thermal expansion coefficient of each nozzle segment differs at most 5% or at most 3% or at most 2% from the thermal expansion coefficient of the casing in a temperature range up to 600° C.

According to a preferred embodiment of the invention, each nozzle segment has a core comprising martensitic steel having a minimum creep rupture strength that fulfills the following conditions at a temperature of 580° C.: at least 10⁵ hours without rupture under a tensile stress of at least 100 MPa or at least 125 MPa or at least 150 MPa. The creep rupture strength is determined by measuring a duration of a material probe under a defined tensile stress until rupture of the probe occurs. This feature can also be used independent from the difference between the thermal expansion coefficients of the casing and the nozzle segments.

Particularly the martensitic steel of the core can be X17CrMoVNbB9-1, i.e. commonly known as “Steel B” or alternatively steel of the type X22CrMoV12-1, Number 1.4923. Other steels may also be used to manufacture nozzle segments 30, such as X10CrWMoVNb9-2 Number 1.4901, X14CrMoVNbN10-2, 9Cr-3W-3Co-VNbBN or X13CrMoCoVNbNB9-2-1, as long as the thermal expansion coefficients thereof are substantially equal to the thermal expansion coefficient of the casing.

In a preferred embodiment the airfoils, the first ring segment and the second ring segment of each nozzle segment are integrally or monolithically made from the same material without seams or joints. For example, each nozzle segment can be machined from an integral solid initial workpiece. During machining material can be removed from the solid workpiece (e.g. by milling or erosion) in order to obtain the desired configuration of the nozzle segment. Alternatively, each nozzle segment can be manufactured by an additive manufacturing technique. In this embodiment each nozzle segment is particularly free of weld joints or adhesive joints or form-fit joints or substance bonds between the airfoils and the ring segments.

Alternatively in another embodiment the airfoils and the ring segments can be manufactured individually and subsequently connected to form a nozzle segment. Particularly the connection between the airfoils and the ring segments can be established by weld joints.

It is advantageous, if the core of each nozzle segment is at least coated in one or more surface areas with a surface coating. Due to the surface coating, the nozzle segment can be made less sensitive to high temperature oxidation and solid particle erosion compared with the material of the core of the nozzle segment.

The surface coating can comprise at least one of chromium, carbon and nickel. In an embodiment the surface coating can comprise chromium carbide (Cr₃C₂), nickel chromium (NiCr) or a combination thereof.

The surface area provided with the surface coating is preferably on the surface of the airfoils. The surface coating can only cover the surface of the airfoils partly or completely. Alternatively the surface coating may in addition cover at least parts of the first or second ring segments of the nozzle segment, preferably a surface area subject to working fluid flow.

The surface coating can be applied on the at least one surface area of the nozzle segment by thermal spraying, preferably High Velocity Oxygen Fuel spraying (HVOF) or High Velocity Air Fuel spraying (HVAF). For example, material of the coating in powder form can be supplied to a burner and emitted by means of a high velocity gas jet onto the at least one surface area to be coated. The surface area to be coated can be roughened prior to the application of the coating material for improving the bond.

By providing nozzle segments comprising multiple airfoils, larger units can be handled during assembly and disassembly of the diaphragm. The nozzle segments are less susceptible to excitation created by the working fluid flow compared with a configuration of the diaphragm with individual airfoils.

The material of the casing supporting the nozzle segments is different from the material of the nozzle segments. Particularly the material of the nozzle segments has higher creep strength than the material of the casing supporting the nozzle segments.

The nozzle segments are subject to length variations due to temperature changes. This may lead to mechanical stress that can reduce the lifetime of the diaphragm or cause failures during operation. Because the thermal expansion coefficient of the nozzle segments and the casing is made substantially equal in the relevant temperature range – particularly also above 570° C. up to 650° C. – the nozzle segments are allowed to enlarge or contract similarly with the casing. As a consequence mechanical stress on the components is reduced. Clearances between directly adjacent nozzle segments and between nozzle segments and the supporting structure of the casing during that are provided during installation can be minimized. As a result not only the reliability, but also the efficiency of the steam turbine is improved.

As material for the casing supporting the nozzle segments martensitic steel can be used that is different from the martensitic steel of the core of the nozzle segment. For example the martensitic steel used for the casing can be of the type GX12CrMoVNbN9-1 Number 1.4955 defined in EN 10213 “Steel castings for pressure purposes”.

In a preferred embodiment of the steam turbine each nozzle segment corresponds to an embodiment of the nozzle segment according to the first aspect of the invention.

A preferred embodiment of the steam turbine comprises two opposed casing grooves that are open on the side facing each other. These casing grooves form a support structure of the casing that is configured to support the nozzle segments. The casing grooves can extend coaxially or circumferentially around the rotary axis of the steam turbine. Each nozzle segment can engage a first casing groove with the first ring segment and the second casing groove with the second ring segment. The casing grooves are arranged with distance to each other in axial direction. In doing so, the airfoils of the nozzle segments are arranged in the gap between the casing grooves in the flow path of the working fluid.

The casing of the steam turbine may comprise a first casing half and a second casing half. One group of nozzle segments can be arranged at the first casing half forming a first diaphragm section. Another group of nozzle segments can be arranged at the second casing half forming a second diaphragm section. The two individual diaphragm sections allow easy assembly and disassembly of the casing halves of the steam turbine casing.

Preferably at least the outermost nozzle segments of each diaphragm section are secured against movement along the extension direction of the casing grooves by at least one securing element in each case. The securing element can create a form-fit and/or force-fit connection between the outermost nozzle segment and the casing half in each case. The outermost nozzle segments are those nozzle segments in each casing half that directly adjoin a separation plane along which the first casing half and the second casing half are connected. By securing the outermost nozzle segments also the intermediate nozzle segments of each diaphragm section are retained between the two outermost nozzle segments of each diaphragm section.

In an embodiment of the steam turbine each nozzle segment can have a ring segment groove in one of the ring segments, preferably the first ring segment. The casing and particularly both casing halves of the steam turbine have an arc-shaped projection engaging the ring segment grooves of the respective nozzle segments. Accordingly, one arc-shaped projection of the first casing half engages the ring segment grooves of the nozzle segments forming the first diaphragm section and one arc-shaped projection of the second casing half engages the ring segment grooves of the nozzle segments forming the second diaphragm section. Preferably each arc-shaped projection extends from a side wall of one of the casing grooves in radial direction with regard to the rotary axis of the steam turbine.

The diaphragm or the diaphragm sections can be assembled with the casing or the casing halves of the steam turbine as follows:

For the assembly nozzle segments are provided, each comprising a first ring segment, a second ring segment and multiple airfoils extending from the first ring segment to the second ring segment. A steam turbine casing is provided having a first casing half and a second casing half. The first casing half may be the upper casing half and the second casing half may be the lower casing half or vice versa. Each casing half is provided with a semi-circular first casing groove and a semi-circular second casing groove arranged opposite each other.

A groove of the provided nozzle segments is used to form a first diaphragm section in the first casing half. For this one of the nozzle segments is inserted into the opposed casing grooves and moved in the desired position. The nozzle segment is clamped by any suitable clamping means in this desired position, e.g. by means of a clamping or braking strip inserted between the nozzle segment and the wall of either the first or second casing groove. Subsequently, the other nozzle segments of the first diaphragm section are inserted in the casing grooves of the first casing half in a similar manner. If necessary or advantageous, clearance shims can be arranged between directly adjacent nozzle segments of the first diaphragm section.

The second diaphragm section is assembled similar to the first diaphragm section in the second casing half.

Preferably the outermost nozzle segments of each diaphragm section are secured at the respective casing half by means of at least one securing element in each case, e.g. a securing pin. The outermost nozzle segments of each diaphragm section are the two nozzle segments directly adjacent to the separation plane between the first and second casing halves. The casing halves are attached to each other along the separation plane. Preferably the separation plane extends in a horizontal direction.

If the outermost nozzle segments of each diaphragm section are secured by securing means and particularly securing pins, the clearance shims may be removed subsequently, such that the nozzle segments of each diaphragm section are arranged next to each other with a defined clearance.

If necessary, the securing elements and particularly the securing pins can be processed or machined to have a desired outer contour that is aligned with the outer contour of the adjacent nozzle segment such that it does not interfere or impede the connection of the two diaphragm sections when attaching first and second casing halves to each other. When the casing halves are attached to each other, the diaphragm sections form a closed circular ring that is preferably arranged coaxially around the rotary axis of the steam turbine.

Preferred embodiments of the steam turbine and the method are disclosed in the dependent claims, the description and the drawings. In the following preferred embodiments of the invention are explained in detail with reference to the attached drawings, in which:

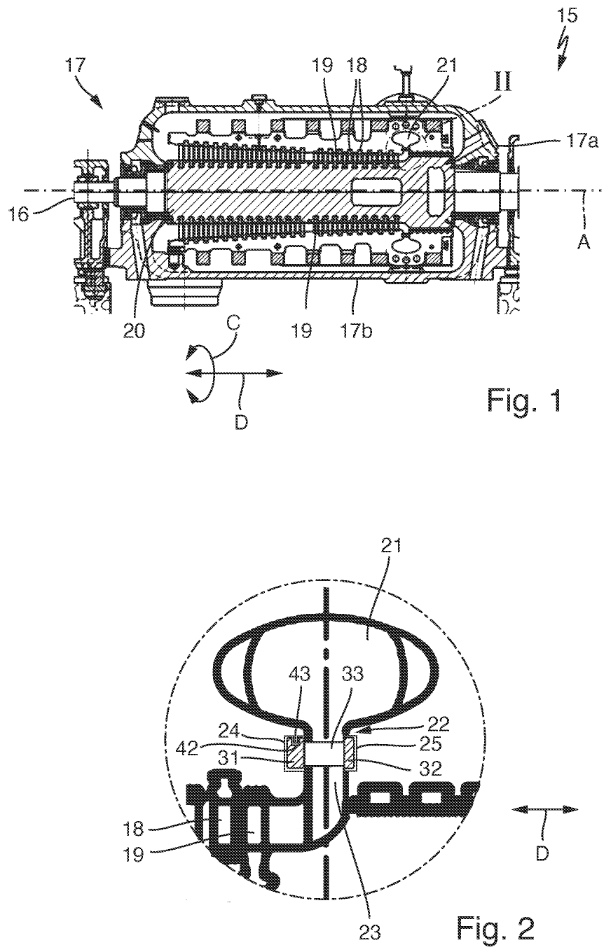

FIG. 1 shows a sectional view along the rotary axis of an embodiment of a steam turbine having a casing and a diaphragm attached to the casing within the flow path of a working fluid,

FIG. 2 is an enlarged illustration of section II in FIG. 1 illustrating the arrangement of the diaphragm on the casing,

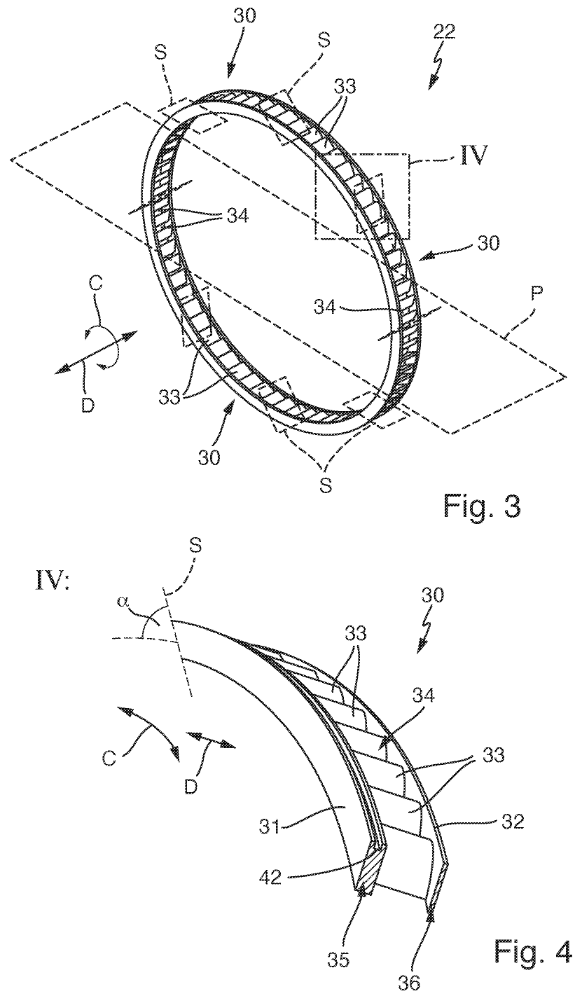

FIG. 3 is a perspective illustration of an embodiment of a diaphragm formed by multiple arc-shaped nozzle segments,

FIG. 4 is a perspective illustration of an embodiment of a nozzle segment of FIG. 3,

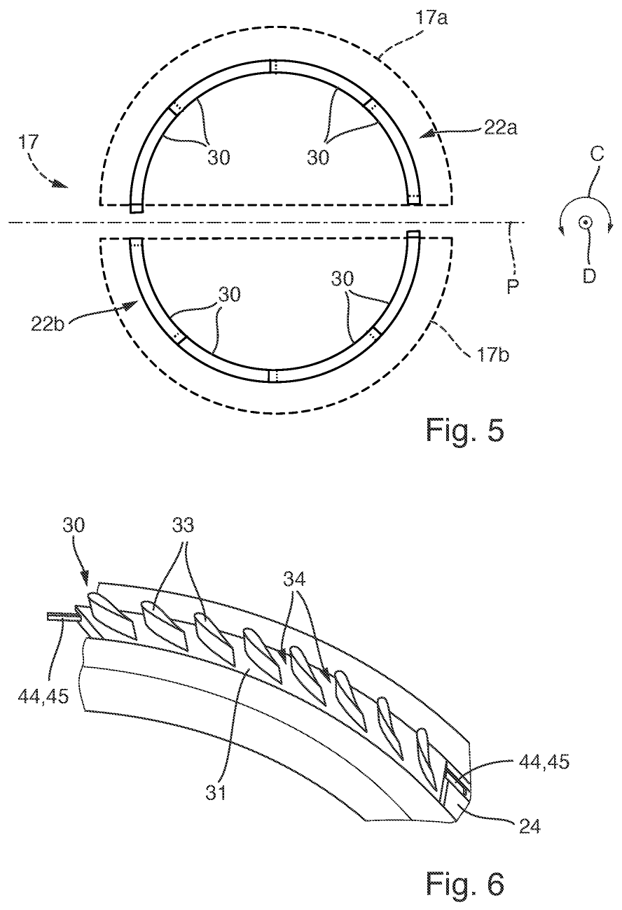

FIG. 5 is a schematic illustration of a first casing half with a first diaphragm section and a second casing half with a second diaphragm section,

FIGS. 6 to 8 show assembly steps during assembly of the nozzle segments in casing grooves of the steam turbine casing,

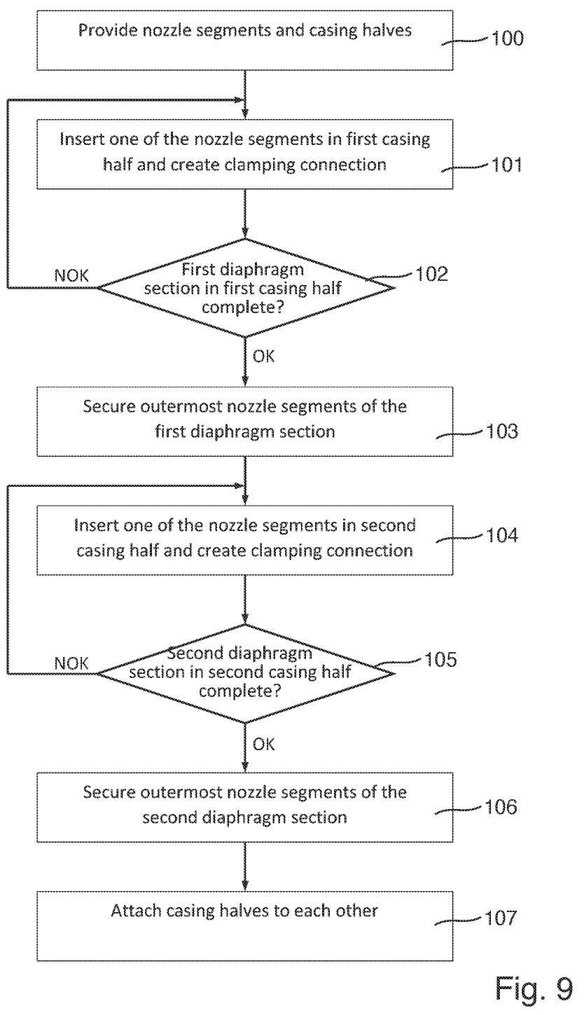

FIG. 9 is a flow diagram of an embodiment of an assembly method for assembling a diaphragm on a casing of a steam turbine

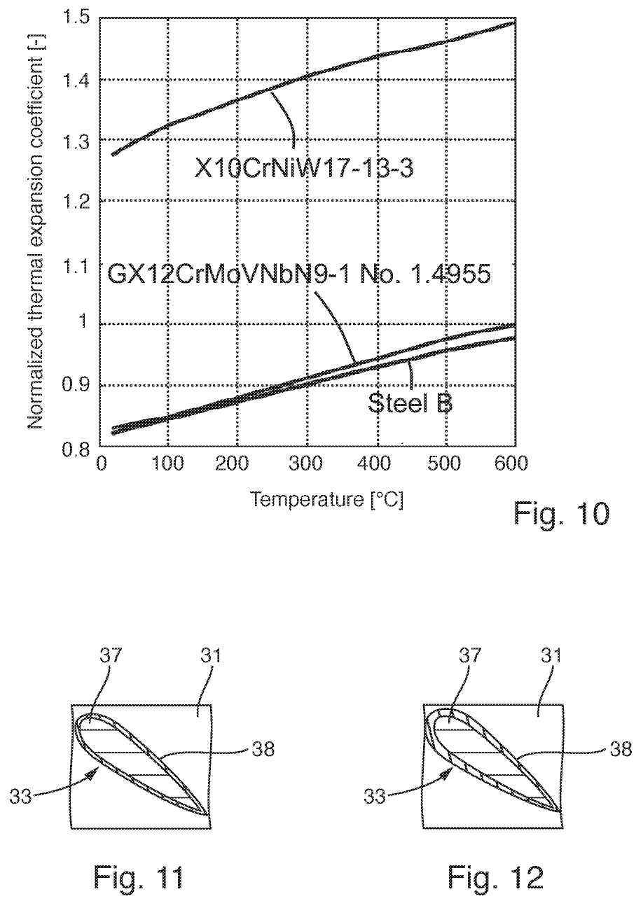

FIG. 10 shows thermal expansion coefficients of different steels, depending on the temperature, and

FIGS. 11 and 12 show schematic cross-sectional views through on airfoil of a nozzle segment.

FIG. 1 shows an embodiment of a steam turbine 15 in a sectional view along a rotary axis A. The rotary axis A is defined by a shaft 16 rotatably supported on a casing 17 of the steam turbine 15. According to the preferred embodiment, the casing 17 comprises a first casing half 17a and a second casing half 17b that are attached to each other along a separation plane P that preferably extends horizontally. The separation plane P is schematically illustrated in FIGS. 3 and 5.

The steam turbine comprises at least one pressure section and can have multiple pressure sections such as a high pressure section and an intermediate pressure section. Each pressure section contains stationary vanes 18 arranged in a ring-shaped manner around the rotary axis A and coupled to the casing 17. Rotary blades 19 of each pressure section and shaft 16 are part of a rotor 20 of the steam turbine.

For driving the rotor 20 a working fluid flows along a fluid path inside the casing 17, wherein the stationary vanes 18 and the rotary blades 19 are arranged in the fluid path of the working fluid. The working fluid is used to rotate the rotor 20 about the rotary axis A.

In this specification the axial direction D is the direction parallel to the rotary axis A. Any direction redial to the rotary axis A is referred to as radial direction. A direction along a circular path around the rotary axis A or the axial direction D is referred to as circumferential direction C.

Upstream of the first pressure section the steam turbine comprises an inlet channel 21 that can also be referred to as inlet scroll. The inlet channel 21 extends in a circumferential direction C around the rotary axis A inside the casing 17. A diaphragm 22 is arranged to guide the working fluid flow from through a fluid connection channel 23 downstream the inlet channel 21 and upstream the at least one pressure section. The inlet channel 21, the diaphragm 22 and the fluid connection channel 23 are partly illustrated in the enlarged illustration of FIG. 2 that corresponds to section II marked in FIG. 1. The working fluid flow upstream the diaphragm 22 is substantially radially toward the rotary axis A. The diaphragm 22 is configured to deflect this flow such that it comprises a flow direction component in circumferential direction C.

The fluid connection channel 23 fluidically connects the inlet channel 21 with the at least one pressure section of the steam turbine 15. Adjacent to the fluid connection channel 23 the casing 17 comprises a first casing groove 24 and a second casing groove 25 that are arranged distant from each other in axial direction D. The casing grooves 24, 25 are aligned with each other such that the open sides of these casing grooves 24, 25 face each other in axial direction D. The fluid connection channel 23 extends between the casing grooves 24, 25. The casing grooves 24, 25 extend coaxially to the rotary axis A. They are configured to support the diaphragm 22 such that the diaphragm 22 extends coaxially around the rotary axis A of the steam turbine 15.

With reference to FIGS. 3 and 4 the diaphragm 22 comprises multiple nozzle segments 30. Each nozzle segment 30 extends in a circular arc-shaped manner in circumferential direction C around the rotary axis A. Together all of the nozzle segments 30 form a closed ring.

The diaphragm 22 comprises, according to the preferred embodiment, eight nozzle segments 30. It has to be noted that the number of nozzle segments 30 of the diaphragm 22 may vary and may be smaller or larger in other embodiments.

As particularly illustrated in FIG. 4, each nozzle segment 30 comprises a first ring segment 31 and a second ring segment 32. The two ring segments are arranged with distance from each other in the axial direction. Multiple airfoils 33 extend between the first ring segment 31 and the second ring segment 32 such that the ring segments 31, 32 are connected with each other by multiple airfoils 33 and thus form an integral or monolithic nozzle segment 30. The number of airfoils 33 of each nozzle segment 30 may vary and according to the example, each nozzle segment can contain 8-12 airfoils 33.

Two directly adjacent airfoils 33 of the nozzle segments 30 limit one opening 34 of the diaphragm 22 through which working fluid might flow. As best illustrated in FIG. 2, the airfoils 33 and the openings 34 are arranged in the fluid connection channel 23 so that working fluid might flow from the inlet channel 21 toward the at least one pressure section of the steam turbine 15 via the openings 34 of the diaphragm 22.

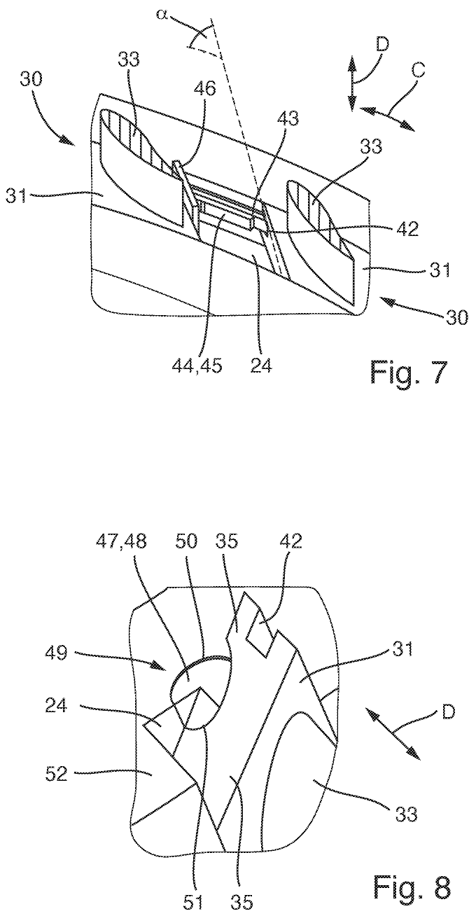

It is apparent from FIGS. 3 and 4 that adjacent nozzle segments 30 have matching first faces 35 at the circumferential end of the first ring segment 31 and second end faces 36 at the circumferential end of the second ring segment 32. The end faces 35, 36 at each circumferential end of a nozzle segment 30 extend preferably in a common intermediate plane S. This intermediate plane S can be aligned in one dimension parallel to the axial direction D and can be inclined with regard to the circumferential direction C. This means that the intermediate planes S are not orientated orthogonal to the circumferential direction C, but include an acute angle α with regard to the circumferential direction C, as schematically illustrated in FIGS. 4 and 7. The angle α can be equal for all intermediate planes S between two directly adjacent nozzle segments 30.

Due to the tilted end faces 35, 36 an overlapping area is obtained in which the respective first ring segments 31 and second ring segments 32 overlap. The overlapping area is positioned inside the first casing groove 24 and the second casing groove 25 respectively.

The casing 17 comprising the first casing half 17a and the second casing half 17b is highly schematically illustrated in FIG. 5. Semicircular sections of the casing grooves 24, 25 are provided in the first casing half 17a and other semicircular sections of the casing grooves 24, 25 are provided in the second casing half 17b. One group of nozzle segments 30 arranged in the first casing half 17a forms a first diaphragm section 22a and the nozzle segments 30 arranged in the second casing half 17b form a second diaphragm section 22b. Each diaphragm section 22a, 22b extends substantially semi-circularly. In the completely assembled condition the two diaphragm sections 22a, 22b form a ring-shaped diaphragm 22 that is coaxially arranged around the rotary axis A. In this assembled condition the two casing halves 17a, 17b are connected to each other along the separation plane P.

The casing 17 and according to the example, the casing halves 17a, 17b are made from a steel alloy that comprises martensitic steel. Preferably at least the support structure of the casing halves 17a, 17b comprising the casing grooves 24, 25 comprises martensitic steel or is made of martensitic steel. The martensitic steel use for the casing 17 is preferably steel of the type Stg9T. The temperature-dependent normalized thermal expansion coefficient of the steel type Stg9T is shown in FIG. 10.

In view of the different requirements regarding the mechanical properties of the casing 17 and the diaphragm 22, the steel type used for casing 17 is not suitable for making the diaphragm 22. In former steam turbines the diaphragm 22 made of the steel type X10CrNiW17-13-3, particularly for applications with working fluid temperatures of more than 570° C. (ultra super critical operating condition). However, additional measures had to be taken to combine this austenitic material with the casing, e.g. by an intermediate layer, e.g. an Alloy 617 weld layer, inserted in the second casing groove 25 in order to adapt the different mechanical properties of the steel types used for the diaphragm 22 and the casing 17. This additional intermediate layer avoided or at least mitigated failures resulting from mechanical stress, particularly due to the different thermal expansion coefficients (compare FIG. 10).

According to the invention, this problem was addressed by using a material for manufacturing the diaphragm 22 or the nozzle segments 30 respectively that matches with the martensitic steel type used to make the casing 17.

According to the invention, the steel contained in the nozzle segments 30 or from which the nozzle segments 30 are made has a thermal expansion coefficient that is substantially equal to the thermal expansion coefficient of the steel comprised in the casing 17 or from which the casing 17 is made - at least the supporting structure for the diaphragm 22 having the casing grooves 24, 25. However, the steel type used for casing 17 is not suitable for making the nozzle segments 30.

In one embodiment the steel used to manufacture the nozzle segments 30 is a martensitic steel having a higher mechanical strength – particularly a higher tensile strength and/or creep strength – than the martensitic steel used for the casing 17. Preferably X17CrMoVNbB9-1, commonly also known as “steel B” or steel of the type St12T is used for making the nozzle segments 30. In the preferred embodiments the martensitic steel used for making the nozzle segments 30 has a minimum creep strength at a temperature of 580° C. This minimum creep strength of the martensitic steel of the core fulfills the following conditions at a temperature of 580° C.: the duration until creep rupture occurs is at least 10⁵ hours under a tensile stress of at least 100 MPa or at least 125 MPa or at least 150 MPa. Other steels may also be used to manufacture nozzle segments 30, such as X10CrWMoVNb9-2 Number 1.4901, X14CrMoVNbN10-2, 9Cr-3W-3Co-VNbBN or X13CrMoCoVNbNB9-2-1, as long as the thermal expansion coefficients thereof are substantially equal to the thermal expansion coefficient of the casing.

FIG. 10 shows that the thermal expansion coefficient of steel B is substantially equal to the thermal expansion coefficient of the steel Stg9T, at least in a temperature range up to 600° C. Specifically in this temperature range the difference between the thermal expansion coefficient of the casing material and the thermal expansion coefficient of the nozzle segment material is less than 0.05 and preferably less than 0.02, as illustrated in FIG. 10.

In the preferred embodiment each nozzle segment 30 has a core 37 made of a martensitic steel having the minimum creep strength, e.g. steel B. At least one or more surface areas of each nozzle segment 30 can be covered with a surface coating 38. The surface areas of each nozzle segment 30 that are covered with the surface coating 38 can be the surfaces of the airfoils 33, as illustrated in FIGS. 11 and 12. The surface coating 38 may have a uniform thickness (FIG. 11) or the thickness of the surface coating 38 may vary (FIG. 12). In the latter case the thickness of the surface coating 38 may be larger in areas of the airfoils 33 that are more susceptible to wear, particularly the area near and at the leading edges, whereas the surface coating 38 may be thinner in the area of the trailing edge of each airfoil 33. Please note that the illustrations in FIGS. 11 and 12 are only schematic and not to scale.

The surface coating 38 may contain at least one of chromium, carbon and nickel. Preferably the surface coating 38 comprises at least one of chromium carbide (Cr₃C₂) and nickel chromium (NiCr). It may be applied to the respective at least one surface area of each nozzle segment 30 and particularly the surface of the airfoils 33 by thermal spraying. For example, High Velocity Oxygen Fuel spraying (HVOF) of High Velocity Air Fuel spraying (HVAF) may be used. The material of the surface coating 38 may be provided in the form of powder and ejected with high velocity by the thermal spraying apparatus onto the surface area to be coated.

Each nozzle segment 30 and according to the example the core 37 of each nozzle segment 30 is made of the same continuous material, particularly steel B, without seams and joints. Thus, each nozzle segment forms an integral unit. Preferably no weld joints, adhesive joints, bolted joints and the like exist between the airfoils 33 and the first and second ring segments 31, 32. Alternatively the airfoils 33 of each nozzle segment 30 may be welded or bonded in any suitable manner to the ring segments 31, 32.

As is apparent from FIG. 4, in axial direction D the dimension of the first ring segment 31 may be larger than the dimension of the second ring segment 32. According to the example, on at least one side of the first ring segment 31 facing in radial direction and preferably on the side facing away from the rotary axis A, a ring segment groove 42 is provided. If the nozzle segment 30 is inserted in the first and second casing grooves 24, 25 of the respective casing half 17a of 17b, a projection 43 extending from a flank limiting the first casing groove 24 engages the ring segment groove 42 as best shown in FIGS. 2 and 7. This form-fit can also be used for clamping nozzle segments 30 in circumferential direction C during assembly as explained in more detail with reference to FIGS. 6 to 9.

FIG. 9 is a flowchart of an embodiment of a method for assembling the diaphragm 22 to the casing 17 of the steam turbine 15.

In a first step 100 the necessary number of nozzle segments 30, e.g. 8 nozzle segments 30, and the two casing halves 17a and 17b are provided. Subsequently, in the second step 101 one of the nozzle segments 30 is inserted into the casing grooves 24, 25 of the first casing half 17a. The inserted nozzle segment 30 is clamped by using a clamping element 44 for creating a force-fit between the inserted nozzle segment 30 and the first casing half 17a. According to the embodiment, the clamping element 44 has the form of a clamping or braking strip 45 that is placed between the bottom of the ring segment groove 42 and the free end of the projection 43 to create a clamping effect when either the nozzle segment 30 is moved onto the braking strip 45 or else the braking strip 45 is inserted from one end into the gap between the projection 43 and the bottom of the ring segment groove 42 (compare FIG. 7).

One clamping element 44 can be used to create a force-fit between the first casing half 17a and two directly adjacent nozzle segments 30. Specifically the braking strip 45 forming the clamping element 44 may have one section that is located in the ring segment groove 42 of one nozzle segment 30 and another section that extends therefrom as illustrated in FIG. 7. The next directly adjacent nozzle segment 30 can be moved onto accessible section of the braking strip 45 to create the desired clamping effect. The clamping elements 44 or braking strips 45 are used to hold the inserted nozzle segments 30 in a desired position during assembly. They do not have to be removed and may remain in the completely assembled casing 17.

If desired to create a defined clearance between two directly adjacent nozzle segments, a clearance shim 46 can be placed in the first casing groove 24 in the second step 101. The clearance shim 46 can have a plate-like configuration and extend along the intermediate plane S. The two directly adjacent nozzle segments 30 can abut against the clearance shim 46 from opposite sides.

In a third step 102 it is checked whether the first diaphragm section 22a is completed, i.e. whether all of the nozzle segments 30 that form the first diaphragm section 22a have been inserted into the casing grooves 24, 25 of the first casing half 17a. If this is the case, the method proceeds with the fourth step 103 (branch OK from third step 102). Else the method repeats the second step 101 again with inserting and clamping the next nozzle segment 30 of this first diaphragm section 22a (branch NOK from third step 102).

In the fourth step 103 the two outermost nozzle segments 30 are secured with a securing element 47 in each case and according to the example, with a securing pin 48. The securing element 47 is inserted with press fit into a securing area at the end of the first casing groove 24 adjoining the separation plane P. This securing area 49 is formed by a casing cavity 50 provided in the bottom of the first casing groove 24 and an aligned segment cavity 51 provided in the first ring segment 31 of the outermost nozzle segment 30. The segment cavity 51 is open to the side of the first ring segment 31 that faces away from the airfoils 33. According to the example, the casing cavity 50 and the segment cavity 51 define a cross-section orthogonal to the circumferential direction C that matches the cross-section of the securing element 47. According to the example, this cross-section is circular.

The securing pin 48 is pressed in the opening defined by the cooperating or aligned cavities 50, 51 such that a tight press fit is created. Alternatively or in addition, a substance bond can be provided between the securing pin 48 and the surfaces limiting the casing cavity 50 and/or the segment cavity 51. This substance bond can be created by gluing and/or welding.

In this manner both outermost nozzle segments 30 that are located directly adjacent to the separation plane P are secured in the first casing half 17a. Subsequently, if clearance shims 46 have been inserted between adjacent nozzle segments, these clearance shims 46 can be removed.

After having inserted the securing pin 48, the end section of the securing pin 48 may be processed or machined such that it does not extend beyond the end contour defined by the first face 35 and the adjacent casing surface 52 into which the casing cavity 50 opens, as illustrated in FIG. 8. According to the example, an end portion of the securing pin 48 is removed to create a chamfer with two angled surface areas, wherein one surface area extends parallel to the first face 35 and the other surface area extends parallel to the bottom of the first casing groove 24. In doing so, connection between the two diaphragm sections 22a, 22b is not impeded by the securing pins 48 that fix the respective outermost nozzle segments 30.

Alternatively, the securing element 47 or securing pin 48 can have the necessary shape or contour in its end section before being inserted in the securing area 49.

The removal of the clearance shims 46 and the processing of the end sections of the securing pins can be carried out at any time during the assembly after the outermost nozzle segments 30 have been secured and before attaching the casing halves 17a, 17b together.

After having completed the assembly of the first diaphragm section 22a in the first casing half 17a, the second diaphragm section 22b is assembled in the second casing half 17b in a similar manner in a fifth step 104, a sixth step 105 and a seventh step 106 of the method. The steps 104-106 correspond to the steps 101-103.

Finally the casing halves 17a, 17b are attached to each other in the eighth step 107 after the assembly of both diaphragm sections 22a, 22b has been completed.

The invention refers to an integral or monolithic nozzle segment 30 having airfoils 33. According to an aspect of the invention a steam turbine has a casing 17 supporting multiple nozzle segments 30 forming a diaphragm 22 with the airfoils 33 located in a channel 23 through which working fluid flows. The diaphragm 22 surrounds a rotary axis A of a steam turbine 15 coaxially and consists of a plurality of individual nozzle segments 30. The nozzle segments 30 and the casing 17 of the steam turbine 15 have substantially equal thermal expansion coefficients. The casing 17 and the nozzle segments 30 are made of different materials and particularly different martensitic steel types. According to yet another aspect of the invention each nozzle segment 30 has a core 37 comprising martensitic steel having a minimum creep strength that fulfills the following conditions at a temperature of 580° C.: at least 10⁵ hours under a tensile stress of at least 100 MPa or at least 125 MPa or at least 150 MPa.

List of Reference Signs:

| | |
|---|---|
| 15 | steam turbine |
| 16 | shaft |
| 17 | casing |
| 17 a | first casing half |
| 17 b | second casing half |
| 18 | stationary vane |
| 19 | rotary blade |
| 20 | rotor |
| 21 | inlet channel |
| 22 | diaphragm |
| 23 | fluid connection channel |
| 24 | first casing groove |
| 25 | second casing groove |
| 30 | nozzle segment |
| 31 | first ring segment |
| 32 | second ring segment |
| 33 | airfoil |
| 34 | opening |
| 35 | first face |
| 36 | second face |
| 37 | core |
| 38 | surface coating |
| 42 | ring segment groove |
| 43 | projection |
| 44 | clamping element |
| 45 | braking strip |
| 46 | clearance shim |
| 47 | securing element |
| 48 | securing pin |
| 49 | securing area |
| 50 | casing cavity |
| 51 | segment cavity |
| 52 | casing surface |
| 100 | first step |
| 101 | second step |
| 102 | third step |
| 103 | forth step |
| 104 | fifth step |
| 105 | sixth step |
| 106 | seventh step |
| 107 | eighth step |
| α | angle |
| A | rotary axis |
| C | circumferential direction |
| D | axial direction |
| P | separation plane |
| S | intermediate plane |

1. A nozzle segment for a diaphragm of a steam turbine, wherein the nozzle segment is configured to be attached to a casing of the steam turbine and wherein each nozzle segment comprises a first ring segment, a second ring segment extending parallel to the first ring segment and multiple airfoils extending between first and second ring segments, wherein each nozzle segment has a core comprising martensitic steel and wherein the thermal expansion coefficient of each nozzle segment differs from the thermal expansion coefficient of the casing of the steam turbine at most 5% in a temperature range up to 600° C.

2. The nozzle segment according to claim 1, wherein the martensitic steel has a minimum creep rupture strength that fulfills the following conditions at a temperature of 580° C.: at least 10 5 hours without fracture under a tensile stress of at least 100 MPa or at least 125 MPa or at least 150 MPa.

3. The nozzle segment according to claim 1, wherein the airfoils, the first ring segment and the second ring segment are integrally machined from the same solid material workpiece without seams or joints.

4. The nozzle segment according to claim 1, wherein the airfoils the first ring segment and the second ring segment are individually made and subsequently connected with each other.

5. The nozzle segment according to claim 1, wherein each nozzle segment has a core comprising martensitic steel.

6. The nozzle segment according to claim 5, wherein the core is made of X17CrMoVNbB9-1.

7. The nozzle segment according to claim 1, wherein at least one surface area of the nozzle segment is provided with a surface coating, and the surface coating comprises at least one of the group chromium, carbon and nickel or at least one of the group titanium, aluminum and nitrogen.

8. The nozzle segment according to claim 7, wherein the surface coating comprises at least one of chromium carbide, nickel chromium and titanium aluminum nitride .

9. The nNozzle segment according to claim 7, wherein the surface coating has a resistance such that arranged within a steam flow at a temperature of 625° C. to 650° C. a loss of material is less than 200 micrometers within a predetermined lifetime of the nozzle segment.

10. A steam turbine comprising:
a casing surrounding at least one turbine pressure section stationary vanes coupled to the casing and rotor blades,
a diaphragm attached to the casing and comprising multiple nozzle segments, wherein each nozzle segment comprises a first ring segment, a second ring segment extending parallel to the first ring segment and multiple airfoils extending between first and second ring segments, and wherein the thermal expansion coefficient of each nozzle segment differs from the thermal expansion coefficient of the casing of the steam turbine at most 0.1% in a temperature range up to 600° C.

11. The steam turbine according to claim 10, wherein the at least the supporting structure of the casing supporting the diaphragm is made of a material that is different from the material of the nozzle segments.

12. The steam turbine according to claim 11, wherein a creep rupture strength of the material of the nozzle segments is larger than a rupture creep strength of the material of the supporting structure of the casing.

13. The steam turbine according to claim 10, wherein the nozzle segments are arranged in two opposed casing grooves.

14. The steam turbine according to claim 10, wherein the casing comprises a first casing half and a second casing half and wherein the group of nozzle segments attached to the first casing half form a first diaphragm section and the group of nozzle segments attached to the second casing half form a second diaphragm section.

15. A method for assembling a diaphragm to a casing of a steam turbine comprising the following steps:
(a) Providing multiple monolithic nozzle segments each comprising a first ring segment, a second ring segment extending parallel to the first ring segment and multiple airfoils extending between first and second ring segments, wherein the thermal expansion coefficient of each nozzle segment differs from the thermal expansion coefficient of the casing of the steam turbine at most 5% in a temperature range up to 600° C.,
(b) Providing a first casing half and a second casing half of a turbine casing each having a semicircular first casing groove and a semicircular second casing groove that are arranged opposite each other,
(c) Inserting one of the nozzle segments in the first and second casing grooves one of the first casing half and clamping the inserted nozzle segment by means of at least one clamping element arranged in one of the casing grooves,
(d) Repeating the previous step (c) with other nozzle segments to form a first semicircular diaphragm section from the multiple nozzle segments in the first casing half,
(e) Repeating the previous steps (c) (d) with the second casing half to form a second semicircular diaphragm section from the multiple nozzle segments in the second casing half.
